(19) United States
(12) Patent Application Publication
(10) Pub. No.: US 2022/0398864 A1
(43) Pub. Date: Dec. 15, 2022

(54) ZOOM BASED ON GESTURE DETECTION

(71) Applicant: Polycom Communications Technology (Beijing) Co., Ltd., Beijing (CN)

(72) Inventors: Xi Lu, Beijing (CN); Tianran Wang, Beijing (CN); Hailin Song, Beijing (CN); Hai Xu, Beijing (CN); Yongkang Fan, Beijing (CN)

(21) Appl. No.: 17/763,173

(22) PCT Filed: Sep. 24, 2019
(86) PCT No.: PCT/CN2019/107415

§ 371 Date: Mar. 23, 2022

(51) Int. Cl. G06V 40/16; G06V 10/75; G06F 3/01

(52) U.S. Cl. CPC G06V 40/165; G06V 10/757; G06F 3/017

(57) ABSTRACT

A method performs zooming based on gesture detection. A visual stream is presented using a first zoom configuration for a zoom state. An attention gesture is detected from a set of first images from the visual stream. The zoom state is adjusted from the first zoom configuration to a second zoom configuration to zoom in on a person in response to detecting the attention gesture. The visual stream is presented using the second zoom configuration after adjusting the zoom state to the second zoom configuration. Whether the person is speaking is determined, from a set of second images from the visual stream. The zoom state is adjusted to the first zoom configuration to zoom out from the person in response to determining that the person is not speaking. The visual stream is presented using the first zoom configuration after adjusting the zoom state to the first zoom configuration.

### BACKGROUND

Video conferencing systems connect multiple people that are remotely located from each other. Specifically, a group of one or more people are at a location that is connected to other locations using two or more video conferencing systems. Each location has at least one video conferencing system. When multiple people are at the same location, a challenge with video conferencing systems that exists is identifying a person that is speaking. Sound source localization (SSL) algorithms may be used, but SSL algorithms require multiple microphones, can be inaccurate due to sound reflections, and can fail when multiple people are speaking. Improvements are needed to identify a person that is speaking and mitigate the shortcomings of current systems.

### SUMMARY

In general, in one aspect, one or more embodiments relate to a method for zooming based on gesture detection. The method includes presenting a visual stream using a first zoom configuration for a zoom state. The method also includes detecting an attention gesture, from a set of first images from the visual stream. The method also includes adjusting the zoom state from the first zoom configuration to a second zoom configuration to zoom in on a person in response to detecting the attention gesture. The method also includes presenting the visual stream using the second zoom configuration after adjusting the zoom state to the second zoom configuration. The method also includes determining, from a set of second images from the visual stream, whether the person is speaking. The method also includes adjusting the zoom state to the first zoom configuration to zoom out from the person in response to determining that the person is not speaking. The method also includes presenting the visual stream using the first zoom configuration after adjusting the zoom state to the first zoom configuration.

In general, in one aspect, one or more embodiments relate to an apparatus for zooming based on gesture detection. The apparatus includes a processor, a memory, and a camera. The memory includes a set of instructions that are executable by the processor and are configured for presenting a visual stream using a first zoom configuration for a zoom state. The instructions are also configured for detecting an attention gesture from a set of first images from the visual stream. The instructions are also configured for adjusting the zoom state from the first zoom configuration to a second zoom configuration to zoom in on a person in response to detecting the attention gesture. The instructions are also configured for presenting the visual stream using the second zoom configuration after adjusting the zoom state to the second zoom configuration. The instructions are also configured for determining, from a set of second images from the visual stream, whether the person is speaking. The instructions are also configured for adjusting the zoom state to the first zoom configuration to zoom out from the person in response to determining that the person is not speaking. The instructions are also configured for presenting the visual stream using the first zoom configuration after adjusting the zoom state to the first zoom configuration.

In general, in one aspect, one or more embodiments relate to a non-transitory computer readable medium comprising computer readable program code for presenting a visual stream using a first zoom configuration for a zoom state. The non-transitory computer readable medium also comprises computer readable program code for detecting an attention gesture from a set of first images from the visual stream. The non-transitory computer readable medium also comprises computer readable program code for adjusting the zoom state from the first zoom configuration to a second zoom configuration to zoom in on a person in response to detecting the attention gesture. The non-transitory computer readable medium also comprises computer readable program code for presenting the visual stream using the second zoom configuration after adjusting the zoom state to the second zoom configuration. The non-transitory computer readable medium also comprises computer readable program code for determining, from a set of second images from the visual stream, whether the person is speaking. The non-transitory computer readable medium also comprises computer readable program code for adjusting the zoom state to the first zoom configuration to zoom out from the person in response to determining that the person is not speaking. The non-transitory computer readable medium also comprises computer readable program code for presenting the visual stream using the first zoom configuration after adjusting the zoom state to the first zoom configuration.

Other aspects of the disclosure will be apparent from the following description and the appended claims.

### BRIEF DESCRIPTION OF DRAWINGS

FIG. 1A and FIG. 1B show diagrams of systems in accordance with disclosed embodiments.

FIG. 2A, FIG. 2B, FIG. 2C, FIG. 2D, and FIG. 2E show flowcharts in accordance with disclosed embodiments.

FIG. 3 and FIG. 4 show examples of user interfaces in accordance with disclosed embodiments.

FIG. 5A and FIG. 5B show computing systems in accordance with disclosed embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, a video conferencing system generates and presents a visual stream that includes multiple people participating in a video conference. A video conference is a conference in which people in different locations are able to communicate with each other in sound and vision. Each location has a group of one or more people. At a location, a person may request attention by performing an attention gesture, such as raising or waving a hand. The video conferencing system detects as an attention gesture using machine learning algorithms. The machine learning algorithms detect the attention gesture from the images from the visual stream. After detecting the attention gesture, the video conferencing system zooms in on the person that requested attention by changing a zoom state from a first zoom configuration for a zoomed out state to a second zoom configuration for a zoomed in state. The second zoom configuration centers in on the person that requested attention. While the person is speaking (i.e., while a speech gesture is detected) the system remains in the zoomed in state. If the person does not speak for a certain amount of time (e.g., 2 seconds), the system returns to the zoomed out state.

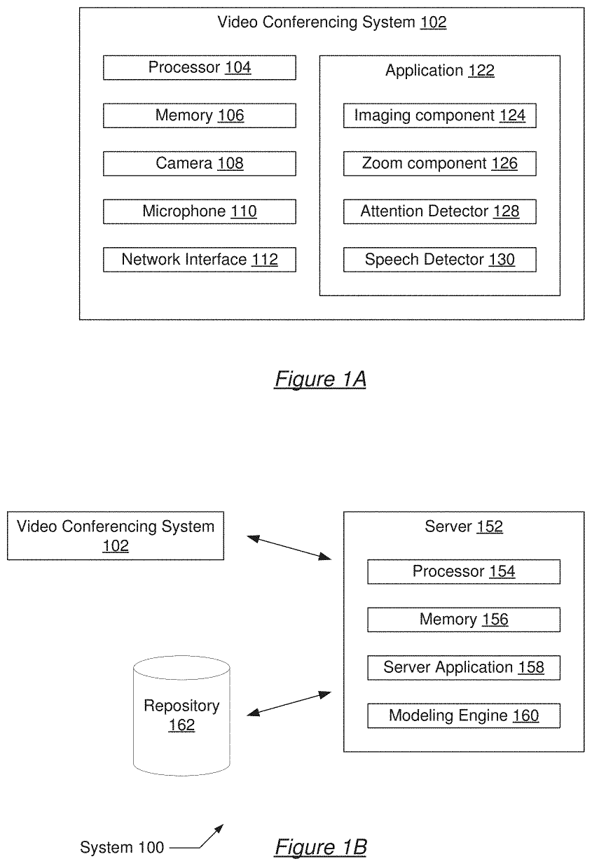

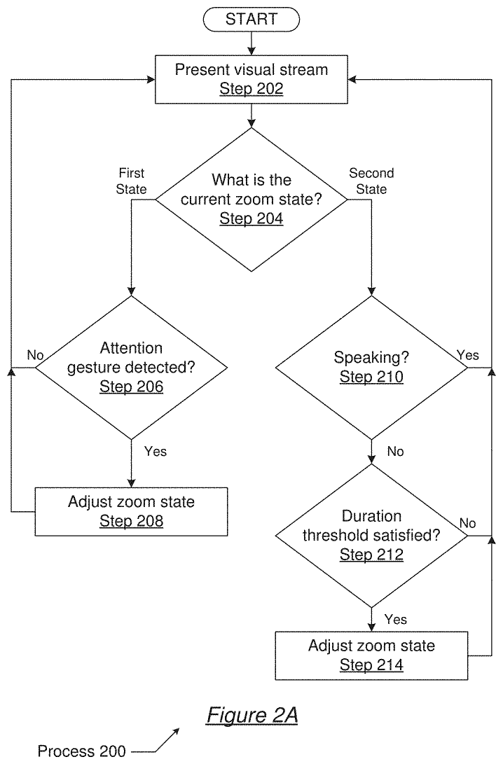

FIG. 1 shows a diagram of embodiments that are in accordance with the disclosure. The various elements, systems, and components shown in FIG. 1 may be omitted, repeated, combined, and/or altered as shown from FIG. 1. Accordingly, the scope of the present disclosure should not be considered limited to the specific arrangements shown in FIG. 1.

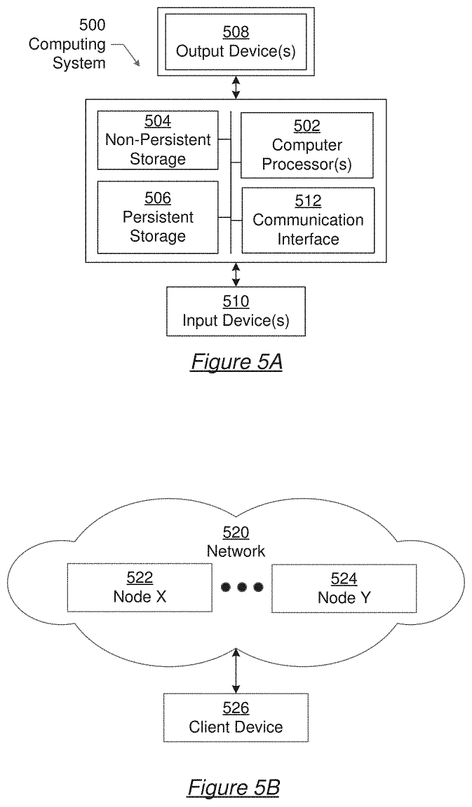

A video conferencing system (102) is video conferencing equipment and integrated software that captures and transmits video and audio for video conferencing. The video conferencing system (102) is configured to perform zooming functions based on gesture detection. The video conferencing system (102) may be an embodiment of the computing system (500) of FIG. 5A. The video conferencing system (102) includes the processor (104), the memory (106), the camera (108), the microphone (110), the network interface (112), and the application (122).

The processor (104) executes the programs in the memory (106). For example, the processor (104) may receive video from the camera (108), receive audio from the microphone (110), generate a stream of visual and audio data, adjust zoom settings, and transmit one or more of the video, audio, and stream to other devices with the network interface (112) using one more standards including the H.323 standard from the International Telecommunications Union (ITU) and the session initiation protocol (SIP) standard. In one or more embodiments, the processor (104) is multiple processors that execute programs and communicate through the network interface (112). In one or more embodiments, the processor (104) includes one or more microcontrollers, microprocessors, central processing units (CPUs), graphical processing units (GPUs), digital signal processors (DSPs), etc.

The memory (106) stores data and programs that are used and executed by the processor (104). In one or more embodiments, the memory (106) is multiple memories that store data and programs that are used and executed by the processor (104). In one or more embodiments, the memory (106) includes the programs of the application (122). The application (122) may be stored and executed on different memories and processors within the video conferencing system (102).

The camera (108) generates images from the environment by converting light into electrical signals. In one or more embodiments, the camera (108) comprises an image sensor that is sensitive to frequencies of light that may include optical light frequencies. In one or more embodiments, the image sensor may be a charge coupled device (CCD) or a complementary metal-oxide semiconductor (CMOS) device.

The microphone (110) converts sound to an electrical signal. In one or more embodiments, the microphone (110) includes a transducer that converts air pressure variations of a sound wave to the electrical signal. In one or more embodiments, the microphone (110) is a microphone array that includes multiple microphones.

The network interface (112) is a hardware component that connects the video conferencing system (102) to other networks. The network interface (112) may connect the video conferencing system (102) to other wired or wireless networks using standards including Ethernet and Wi-Fi.

The application (122) is a collection of components that operate aspects of the video conferencing system (102). The components of the application (122) may be implemented as software components, hardware components, and a mixture of hardware and software components. As an example, the application (122) and its components may be programs stored in the memory (106) and executed by the processor (104). The application (122) includes the imaging component (124), the zoom component (126), the attention detector (128), and the speech detector (130).

The imaging component (124) processes the images for the application (122). In one or more embodiments, the imaging component (124) receives images from the camera (108) and may apply zoom settings from the zoom component (126). In one or more embodiments, the images are the images from the video stream.

The zoom component (126) maintains the zoom state for the application (122). In one or more embodiments, the zoom state identifies a zoom configuration that includes multiple zoom settings. The zoom settings include a zoom amount and a zoom direction for a zoom amount. The zoom amount is the amount of the zoom. The zoom direction is the direction for aiming the zoom. A first zoom configuration may be for a zoomed out state for multiple participants. A second zoom configuration may be a zoomed in state for a particular person.

The attention detector (128) is configured to detect whether a person is requesting attention. In one or more embodiments, the attention detector (128) comprises circuits and programs for one or more machine learning models that identify whether a person is requesting attention from the images from the imaging component (124).

The speech detector (130) is configured to detect whether a person is speaking. In one or more embodiments, the speech detector (130) comprises circuits and programs for one or more machine learning models that identify whether a person is speaking from the images from the imaging component (124).

Turning to FIG. 1B, the system (100) includes a set of components to train and distribute the machine learning models used for zooming based on gesture detection. In one or more embodiments, the system (100) includes the video conference system (102) described in FIG. 1A, the server (152), and the repository (162).

The video conferencing system (102), which is further described in FIG. 1A, may include multiple machine learning models. For example, a first machine learning model may be configured to detect an attention gesture, and a second machine learning model may be configured to detect when a person is speaking. In one or more embodiments, the machine learning models may be one or more of statistical models, artificial neural networks, decision trees, support vector machines, Bayesian networks, genetic algorithms, etc. In one or more embodiments, the machine learning models are provided to the video conference system (102) after being trained by the server (152).

The server (152) trains the machine learning models used by the video conferencing system (102). The server (152) may be an embodiment of the computing system (500) of FIG. 5A. In one or more embodiments, the server (152) includes multiple virtual servers hosted by a cloud services provider. In one or more embodiments, the server (152) includes the processor (154), the memory (156), the server application (158), and the modeling engine (160).

The processor (154) executes the programs in the memory (156). For example, the processor (154) may receive training data from the repository (162), train machine learning models using the training data, store the updated models in the repository (162), and transmit the models to the video conferencing system (102). In one or more embodiments, the processor (104) is multiple processors and may include one or more microcontrollers, microprocessors, central processing units (CPUs), graphical processing units (GPUs), digital signal processors (DSPs), etc.

The memory (156) stores data and programs that are used and executed by the processor (154). In one or more embodiments, the memory (156) includes multiple memories that store data and programs that are used and executed by the processor (154). In one or more embodiments, the memory (156) includes the programs that form the server application (158) and the modeling engine (160).

The server application (158) is a set of components that operate on the server (152). In one or more embodiments, the server application (158) includes the hardware and software components that interface with the repository (162) to transfer training data and machine learning models and that interface with the video conference system (102) to capture new training data and to transfer updated machine learning models.

The modeling engine (160) is a set of components that operate on the server (152). In one or more embodiments, the modeling engine (160) includes the hardware and software components that train the machine learning models that recognize gestures for attention and speech.

The repository (162) is a set of components that include the hardware and software components that store data used by the system (100). The repository (162) may store the machine learning models that are deployed by the server (152) to the video conferencing system (102) and may store the training data used to train the machine learning models. In one or more embodiments, the repository (162) is any type of storage unit and/or device (e.g., a file system, database, collection of tables, or any other storage mechanism) for storing data. Further, the repository (162) may include multiple different storage units and/or devices. The multiple different storage units and/or devices may or may not be of the same type or located at the same physical site.

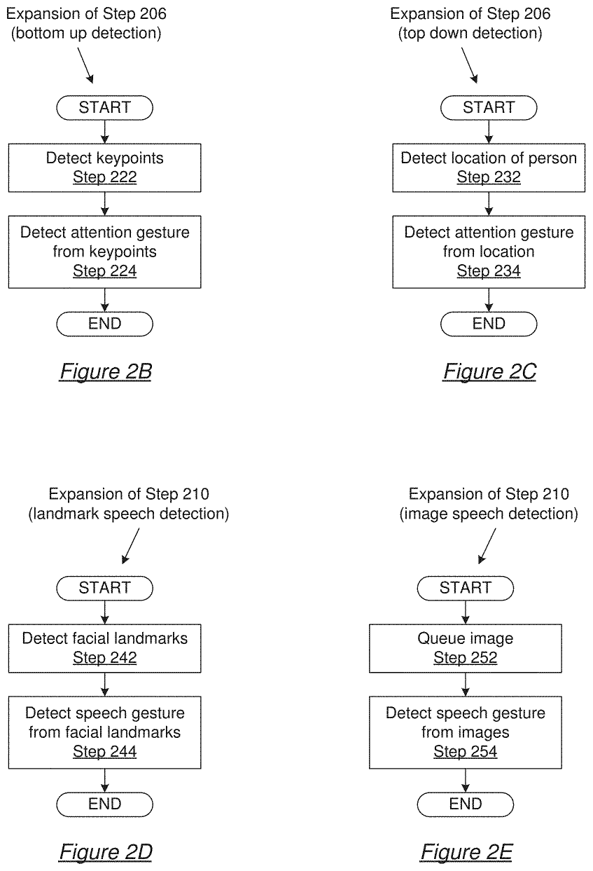

FIG. 2A through FIG. 2E show flowcharts of methods in accordance with one or more embodiments of the disclosure for zooming based on gesture detection. While the various steps in the flowcharts are presented and described sequentially, one of ordinary skill will appreciate that at least some of the steps may be executed in different orders, may be combined or omitted, and at least some of the steps may be executed in parallel. Furthermore, the steps may be performed actively or passively. For example, some steps may be performed using polling or be interrupt driven in accordance with one or more embodiments. By way of an example, determination steps may not have a processor process an instruction unless an interrupt is received to signify that condition exists in accordance with one or more embodiments. As another example, determinations may be performed by performing a test, such as checking a data value to test whether the value is consistent with the tested condition in accordance with one or more embodiments.

Turning to FIG. 2A, the process (200) may be executed on a video conferencing system to zoom based on gesture detection. In Step 202, a visual stream is presented. In one or more embodiments, the visual stream is presented by transmitting a sequence of images generated from a camera of the video conference system to a display device and by displaying the images from the camera on the display device. The visual stream is presented with a zoom state using a zoom configuration that includes zoom settings. A zoomed out state may have a zoom configuration that includes zoom settings for showing all of the people in front of the video conferencing system and for showing the entirety of an image captured with a camera of the video conferencing system. A zoomed in state may have a zoom configuration with zoom settings for showing a particular person that is in an image captured by the camera of the video conferencing system.

In Step 204, the current zoom state is identified. In one or more embodiments, the current zoom state may be one of a set of zoom configurations that include a first zoom configuration for the zoomed out state and a second zoom configuration for the zoomed in state. When the current zoom state is in the first configuration (the zoomed out state), the process proceeds to Step 206. When the current zoom state is in the second zoom configuration (the zoomed in state), the process proceeds to Step 210.

In Step 206, an attention gesture may be detected. In one or more embodiments, an attention detector detects an attention gesture from a set of one or more images from the visual stream. Attention detection may be performed using bottom up detection, which is further discussed at FIG. 2B, and may performed using top down detection, which is further discussed at FIG. 2C. Types of attention gestures may include raising a hand and waving a hand. When an attention gesture is detected, the process proceeds to Step 208. When the attention gesture is not detected, the process proceeds back to Step 202.

In Step 208, the zoom state is adjusted based on the attention gesture detection. In one or more embodiments, the zoom state is changed from the zoomed out state to the zoomed in state. The zoom state may be changed by adjusting one or more zoom settings to switch from the first zoom configuration to the second zoom configuration. In one or more embodiments, the zoom configurations include the zoom settings for an x coordinate, a y coordinate, a width, and a height. The zoom settings may be relative to an original image from the visual stream. The zoom settings of the second zoom configuration may identify a portion of an image from the visual stream that includes the person that made an attention gesture. One or more of the zoom settings for the second zoom configuration may be adjusted to achieve a particular aspect ratio of height to width, which may be the same as the aspect ratio of the original image.

In one or more embodiments, a zoom component adjusts the zoom state based on information from an attention detector. The attention detector may return the rectangular coordinates of a person that requested attention by performing body movements that are recognized as an attention gesture. The zoom settings of the zoom configuration for the adjusted zoom state may be derived from the rectangular coordinates for the person in the original image and include buffer zones to prevent the image of the person from being at an edge of the zoomed image. The zoom settings may also have a modified resolution for the aspect ratio to match the aspect ratio of the original image. For example, an original image may have an original resolution of 1920 by 1080 (a 16 by 9 aspect ratio) and a person performing an attention gesture may be detected within the rectangular area having the bottom, left, top, and right coordinates of (100, 500, 420, 700) within the original image (with the bottom, left coordinates of (0,0) specifying the bottom left origin of the original image). The rectangular area with the person has a resolution of 200 by 320 for an aspect ratio of 10 by 16. The horizontal dimension may be expanded to prevent cropping the vertical dimension. A buffer of about 5% may be added both above and below the vertical dimension to prevent the person from appearing at the edge of a zoomed image making the vertical resolution about 352. Expanding the horizontal resolution to keep a 16 by 9 aspect ratio yields a horizontal resolution of about 625. The zoom settings for the zoom configuration may identify the zoomed rectangle with bottom, left, top, and right coordinates of (84, 287, 436, 912). The zoomed rectangle may then be scaled up back to the original resolution of 1920 by 1080 and presented by the video conferencing system. Additionally, the attention detector may return the x and y coordinates of the head or face of the person requesting attention and the zoom component may center the zoom rectangle onto the center of the head or face of the person.

In Step 210, whether a person is speaking may be detected. In one or more embodiments, a speech detector detects whether a person is speaking from a set of one or more images from the visual stream. Speech detection may be performed using facial landmarks, which is further discuss at FIG. 2D, and may performed using images directly, as discussed at FIG. 2E. When speech is detected, the process proceeds back to Step 202. When speech is not detected, the process proceeds to Step 212.

In additional embodiments, when speech is detected the zoom configuration may be updated to keep the person in the center of the image of the visual stream presented by the video conferencing system. The machine learning algorithm that identifies the location of the person may run in parallel to the machine learning algorithm that determines whether the person is speaking. The output from the machine learning algorithm that determines the location of the person may be used to continuously update the zoom configuration with zoom settings that keep the head or face of the person in the center of the image, as discussed above in relation to Step 208. For example, the system may detect a changed location of the person while presenting the visual stream using the second zoom configuration (i.e., while zoomed in on the person). The system may then adjust the second zoom configuration using the changed location by updating the bottom, left, top, and right coordinates of for the zoom settings of the second zoom configuration to correspond to the changed location of the person in the image.

In Step 212, a duration threshold is checked. In one or more embodiments, the duration threshold indicates a length of time that, if there is no speech detected during that length of time, the system will adjust the zoom state back to the zoomed out state. In one or more embodiments, the duration threshold is in the range of one to three seconds. When the duration threshold is satisfied, the process proceeds to Step 214. When the duration threshold is not satisfied, the process proceeds back to Step 202. For example, with a duration threshold of 2 seconds, when the person onto which the video conferencing system has zoomed has not spoken for 2 seconds, then the system will adjust the zoom state to zoom back out from the person.

In Step 214, the zoom state is adjusted based on whether the person is speaking. In one or more embodiments, the zoom state is changed from the zoomed in state to the zoomed out state. The zoom state may be changed by adjusting one or more zoom settings to transition from the second zoom configuration to the first zoom configuration. For example, the zoom settings may be returned to the original zoom settings from the first zoom configuration by setting the x and y coordinates to 0 and setting the height and width to the resolution of the image from the visual stream.

Turning to FIG. 2B, FIG. 2B is an expansion of Step 206 from FIG. 2A and is an example of using bottom up detection for attention gesture detection. With bottom up detection, keypoints are detected from the image and then whether a person is performing an attention gesture is detected from the keypoints detected from one or more images.

At Step 222, keypoints are detected. In one or more embodiments, the keypoints are detected with an attention detector from an image from the visual stream for the people depicted within the image. A keypoint is a reference location that is a defined location with respect to a human body. For example, keypoints for the location of feet, knees, hips, hands, elbows, shoulders, head, face, etc. may be detected from the image. In one or more embodiments, the attention detector uses a machine learning model that includes an artificial neural network with one or more convolutional layers to generate the keypoints from the image. The machine learning model may be trained using backpropagation to update the weights of the machine learning model.

Examples of neural networks for keypoint detection include PoseNet detector and OpenPose detector, which take an image as input data and generate locations and confidence scores for 17 keypoints as output data. The number of layers used in the networks may be based on which network architecture is loaded. As an example, when using PoseNet detector with a MobileNetV1 architecture and a 0.5 multiplier, the number of layers may be 56.

At Step 224, an attention gesture is detected from the keypoints. In one or more embodiments, the attention detector analyzes the location of a set of keypoints over a duration of time to determine whether an attention gesture has been made by a person. As an example, when it is detected that a hand keypoint is above the elbow keypoint or the shoulder keypoint of the same arm for a person, the attention detector may identify that the person has raised a hand to request attention and indicate that an attention gesture has been detected. As another example, the keypoints from a set of multiple images may be analyzed to determine that a person is waving a hand back and forth to request attention. The analysis of the keypoints may be performed directly by identifying the relative positions, velocities, and accelerations of the keypoints of a person to a set of threshold values for the attention gestures. In additional embodiments, the analysis of the keypoints may be performed using an additional machine learning model that takes the set of keypoints over time as an input and outputs whether an attention gesture has been performed and may utilize an artificial neural network model in addition to the artificial neural network used to generate the keypoints from the image. When an attention gesture is detected, the attention detector may return a binary value indicating that the gesture has been detected and may also return the keypoints of the person that made the attention gesture, which may be used to adjust the zoom state.

Examples of neural networks for gesture detection from keypoints include spatial temporal graph convolutional network (ST-GCN) and hybrid code network (HCN), which take the location of a set of keypoints over a duration of time as input data and generate the confidence scores of different action classes as output data. The action class with the highest score may be identified as the predicted action class.

The size of output layer may be adjusted and the network retrained. For example, the size of the output layer may be adjusted to have two action classes with one action class for whether a person is waving or raising a hand and another action class for whether a person is not waving or raising a hand.

Turning to FIG. 2C, FIG. 2C is an additional or alternative expansion of Step 206 from FIG. 2A and is an example of using top down detection for attention gesture detection. In one or more embodiments, top down detection may be used instead of or in addition to bottom up detection when the image is of low quality or low resolution and the keypoints may not be accurately detected. With top down detection, whether a person is present in the image and the location of the person are first detected and then whether the person is performing at attention gesture may be detected from the location of the person.

In Step 232, the location of the person is detected. In one or more embodiments, the attention detector uses top down detection with a machine learning model that takes an image as input and outputs the location of a person within the image. In one or more embodiments, the machine learning model may include an artificial neural network with multiple convolutional layers that identify the pixels of the image that include the person. A rectangle that includes the identified pixels of the person may be generated to identify the location of the person in the image.

Examples of convolutional neural network (CNN) models for detecting a person in real time on mobile device include MobilenetV2 network and YOLOv3 network. The number of layers and parameter values may be different between different networks. The CNN model for detecting a person may take an image as input data and generate bounding boxes (rectangles) that identify the location of a person in the image as output data.

In Step 234, an attention gesture is detected from the location. In one or more embodiments, the attention detector uses another machine learning model that takes the image at the location as an input and outputs whether an attention gesture was made by the person at the location. In one or more embodiments, the machine learning model for detecting an attention gesture from the location may include an artificial neural network with multiple convolutional layers that provides a probability or binary value as the output to identify whether an attention gesture has been detected.

Examples of neural network models for recognizing gestures include T3D model and DenseNet3D model. The neural network model for recognizing gestures may take a sequence of images as input data and output a gesture label that identifies whether a person is waving a hand or not.

Turning to FIG. 2D, FIG. 2D is an expansion of Step 210 from FIG. 2A and is an example of using facial landmarks for speech detection. At Step 242, facial landmarks are detected. A facial landmark is a reference location that is a defined location with respect to a human body and specifically to a human face. For example, facial landmarks for the locations of the corners of the mouth, the corners of eyes, the silhouette of the jaw, the edges of the lips, the locations of the eyebrows, etc. may be detected from an image from the visual stream.

An example of a neural network model for detecting facial landmarks is the face recognition tool in dlib model. The model takes an image as input data and generates locations of 68 facial landmarks as output data. The 68 facial landmarks include 20 landmarks that are mouth landmarks representing the locations of features of the mouth of the person.

At Step 244, a speech gesture is detected from facial landmarks. In one or more embodiments, a speech gesture may be recognized from a movement of the jaw or lips of the person, which are identified from the facial landmarks. In one or more embodiments, the facial landmarks detected from an image are compared to facial landmarks detected from previous images to determine whether a person is speaking. For example, the speech detector may identify the relative distance between the center of the upper lip and the center of the lower lip as a relative lip distance. The relative lip distance for a current image may be compared to the relative lip distance generated from a previous image to determine whether the lips of the person have moved from the previous image to the current image.

Examples of neural network models for speech gesture detection from keypoints or landmarks include ST-GCN model and HCN model. In one or more embodiments, 20 mouth landmarks are used instead of the body keypoints (e.g., keypoints for shoulders, elbows, knees, etc.). The mouth landmarks over a duration of time are used as the input data. The size of output layer is adjusted to two output classes and the neural network model is retrained to determine whether a person is speaking (the first class) or whether a person is not speaking (the second class).

Turning to FIG. 2E, FIG. 2E is an additional or alternative expansion of Step 210 from FIG. 2A and is an example of speech detection from images. In one or more embodiments, image speech detection may be used instead of or in addition to landmark speech detection when the image is of low quality or low resolution and the facial landmarks may not be accurately detected.

At Step 252, an image is queued. In one or more embodiments, the speech detector queues a set of multiple images (e.g., 5 images) from the visual stream. Adding a new image to the queue removes the oldest image from the queue.

At Step 254, a speech gesture is detected from the images. In one or more embodiments, the speech detector inputs the queue of images to a machine learning model that outputs a probability or binary value that represents whether the person in the image is speaking. When the output is above a threshold (e.g., 0.8) or is a true value, a speech gesture has been detected. As an example, the machine learning algorithm may include an artificial neural network that includes multiple convolutional layers and that is trained with backpropagation.

Examples of neural network models for speech gesture detection from images include T3D model and DenseNet3D model. Embodiments of these neural network models take a sequence of images as input data and output the gesture label to identify whether the person is speaking or whether the person is not speaking.

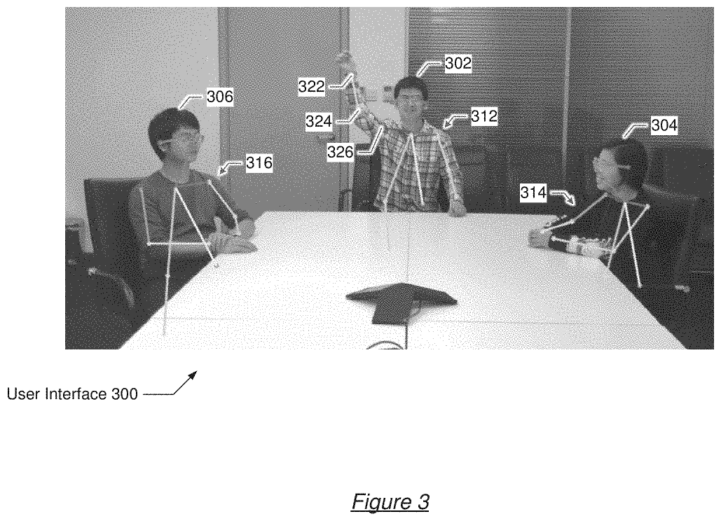

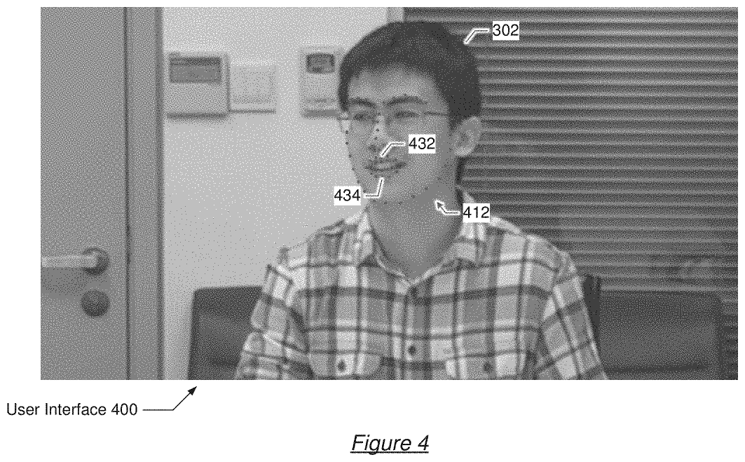

FIG. 3 and FIG. 4 show user interfaces in accordance with the disclosure. The various elements, widgets, and components shown in FIG. 3 and FIG. 4 may be omitted, repeated, combined, and/or altered as shown from FIG. 3 and FIG. 4. Accordingly, the scope of the present disclosure should not be considered limited to the specific arrangements shown in FIG. 3 and FIG. 4.

Turning to FIG. 3, the user interface (300) is in a first zoom state that is zoomed out to show the three people (302), (304), and (306) that are participating in a video conference with a video conferencing system. The sets of keypoints (312), (314), (316) are detected by the video conferencing system for the people (302), (304), (306), respectively and are overlaid onto the image presented in the user interface (300). The set of keypoints (312) includes the wrist keypoint (322), the elbow keypoint (324), and the shoulder keypoint (326).

An attention gesture is detected from the person (302). In one or more embodiments, the attention gesture is detected from the wrist keypoint (322) being above one or more of the elbow keypoint (324) and the shoulder keypoint (326).

In additional embodiments, the set of keypoints (312) may be compared to the sets of keypoints from previous images to detect an attention gesture from the movement of the keypoints over time. For example, horizontal movement of the wrist keypoint (322) may be associated with an attention gesture detected from the person (302) waving a hand.

Turning to FIG. 4, the user interface (400) is in a second zoom state that is zoomed in on the person (302) that previously requested attention and performed a body movement that was detected as an attention gesture. The set of facial landmarks (412) are detected from and overlaid onto the image of the person (302). The set of facial landmarks (412) include the center upper lip landmark (432) and the center lower lip landmark (434).

In one or more embodiments, whether the person (302) is speaking is determined from the sets of facial landmarks detected from one or more images of the person (302). For example, the relative lip distance between the center upper lip landmark (432) and the center lower lip landmark (434) may be compared to the relative lip distance from previous images of the person (302). When the amount of change between the current relative lip distance to the previous relative lip distance satisfies a threshold, a speech gesture is detected and the zoom state remains the same because the person (302) has been identified as speaking. If the change in the relative distances does not satisfy the threshold, then a speech gesture is not detected. In one or more embodiments, when a speech gesture is not detected for a threshold duration (e.g., one and a half seconds) then the zoom state may be adjusted to zoom back out and show the other people participating in the video conference.

Embodiments may be implemented on a computing system. Any combination of mobile, desktop, server, router, switch, embedded device, or other types of hardware may be used. For example, as shown in FIG. 5A, the computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), and numerous other elements and functionalities.

The computer processor(s) (502) may be an integrated circuit for processing instructions. For example, the computer processor(s) may be one or more cores or micro-cores of a processor. The computing system (500) may also include one or more input devices (510), such as a touchscreen, keyboard, mouse, microphone, touchpad, electronic pen, or any other type of input device.

The communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (500) in FIG. 5A may be connected to or be a part of a network. For example, as shown in FIG. 5B, the network (520) may include multiple nodes (e.g., node X (522), node Y (524)). Nodes may correspond to a computing system, such as the computing system shown in FIG. 5A, or a group of nodes combined may correspond to the computing system shown in FIG. 5A. By way of an example, embodiments of the disclosure may be implemented on a node of a distributed system that is connected to other nodes. By way of another example, embodiments of the disclosure may be implemented on a distributed computing system having multiple nodes, where portions of the disclosure may be located on a different node within the distributed computing system. Further, one or more elements of the aforementioned computing system (500) may be located at a remote location and connected to the other elements over a network.

Although not shown in FIG. 5B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources. By way of another example, the node may correspond to a virtual server in a cloud-based provider and connect to other nodes via a virtual network.

The nodes (e.g., node X (522), node Y (524)) in the network (520) may be configured to provide services for a client device (526). For example, the nodes may be part of a cloud computing system. The nodes may include functionality to receive requests from the client device (526) and transmit responses to the client device (526). The client device (526) may be a computing system, such as the computing system shown in FIG. 5A. Further, the client device (526) may include and/or perform at least a portion of one or more embodiments of the disclosure.

The computing system or group of computing systems described in FIGS. 5A and 5B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data which may include resending a response that in whole or in-part fulfilled an earlier request. Finally, the server process then generates a reply including at least the requested data and transmits the reply to the client process. The data may be transferred, more commonly, as datagrams or a stream of characters (e.g., bytes). The server and client may choose to use a unique identifier for each pair of request response data exchanges in order to keep track of data requests that may be fulfilled, partially fulfilled, or have been disrupted during computation.

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, only one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, camera, microphone, eye-tracker, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system in FIG. 5A. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail-such as in nested packet headers or nested document sections). Then, the raw, unprocessed stream of data symbols is parsed, in the context of the organizing pattern, into a stream (or layered structure) of tokens (where tokens may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 5A, while performing one or more embodiments of the disclosure, may perform data comparison. Data comparison may be used to compare two or more data values (e.g., A, B). For example, one or more embodiments may determine whether A>B, A=B, A !=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B includes comparing the first element of vector A with the first element of vector B, the second element of vector A with the second element of vector B, etc. In one or more embodiments, if A and B are strings, the binary values of the strings may be compared.

The computing system in FIG. 5A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g., join, full join, count, average, etc.), sort (e.g., ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 5A may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 5A and the nodes and/or client device in FIG. 5B. Other functions may be performed using one or more embodiments of the disclosure.

While the disclosure has been described with respect to a limited number of embodiments, those skilled in the art, having benefit of this disclosure, will appreciate that other embodiments can be devised which do not depart from the scope of the disclosure. Accordingly, the scope of the disclosure should be limited only by the attached claims.

What is claimed is:

1. A method comprising:
presenting a visual stream using a first zoom configuration for a zoom state;
detecting an attention gesture from a set of first images from the visual stream;
adjusting the zoom state from the first zoom configuration to a second zoom configuration to zoom in on a person in response to detecting the attention gesture;
presenting the visual stream using the second zoom configuration after adjusting the zoom state to the second zoom configuration;
determining, from a set of second images from the visual stream, whether the person is speaking;
adjusting the zoom state to the first zoom configuration to zoom out from the person in response to determining that the person is not speaking; and
presenting the visual stream using the first zoom configuration after adjusting the zoom state to the first zoom configuration.

2. The method of claim 1, wherein detecting the attention gesture further comprises:
detecting a set of keypoints for the person from a first image from the set of first images; and
detecting the attention gesture from the set of keypoints that indicates the person is requesting attention.

3. The method of claim 1, wherein detecting the attention gesture further comprises:
detecting a location of the person from an image from the set of first images; and
detecting an attention gesture from the image at the location, wherein the second zoom configuration comprises an identifier of the location.

4. The method of claim 1, wherein determining whether the person is speaking further comprises:
detecting a facial landmark set for the person from an image of the set of second images; and
detecting that the person is speaking from a plurality of facial landmark sets that include the facial landmark set.

5. The method of claim 1, wherein determining whether the person is speaking further comprises:
queueing an image of the set of second images into an image queue; and
detecting that the person is speaking from the image queue using a machine learning algorithm.

6. The method of claim 1, further comprising:
detecting the attention gesture after determining that the zoom state includes the first zoom configuration; and
determining whether the person is speaking after determining that the zoom state includes the second zoom configuration.

7. The method of claim 1, further comprising:
detecting a changed location of the person while presenting the visual stream using the second zoom configuration; and
adjusting the second zoom configuration using the changed location.

8. An apparatus comprising:
a processor;
a memory;
a camera;
the memory comprising a set of instructions that are executable by the processor and are configured for:
presenting a visual stream using a first zoom configuration for a zoom state;
detecting an attention gesture from a set of first images from the visual stream;
adjusting the zoom state from the first zoom configuration to a second zoom configuration to zoom in on a person in response to detecting the attention gesture;
presenting the visual stream using the second zoom configuration after adjusting the zoom state to the second zoom configuration;
determining, from a set of second images from the visual stream, whether the person is speaking;
adjusting the zoom state to the first zoom configuration to zoom out from the person in response to determining that the person is not speaking; and
presenting the visual stream using the first zoom configuration after adjusting the zoom state to the first zoom configuration.

9. The apparatus of claim 8 with the instructions for detecting the attention gesture further configured for:
detecting a set of keypoints for the person from a first image from the set of first images; and
detecting the attention gesture from the set of keypoints that indicates the person is requesting attention.

10. The apparatus of claim 8 with the instructions for detecting the attention gesture further configured for:
detecting a location of the person from an image from the set of first images; and
detecting an attention gesture from the image at the location, wherein the second zoom configuration comprises an identifier of the location.

11. The apparatus of claim 8 with the instructions for determining whether the person is speaking further configured for:
detecting a facial landmark set for the person from an image of the set of second images; and
detecting that the person is speaking from a plurality of facial landmark sets that include the facial landmark set.

12. The apparatus of claim 8 with the instructions for determining whether the person is speaking further configured for:
queueing an image of the set of second images into an image queue; and
detecting that the person is speaking from the image queue using a machine learning algorithm.

13. The apparatus of claim 8 with the instructions further configured for:
detecting the attention gesture after determining that the zoom state includes the first zoom configuration; and
determining whether the person is speaking after determining that the zoom state includes the second zoom configuration.

14. The apparatus of claim 8 with the instructions further configured for:
detecting a changed location of the person while presenting the visual stream using the second zoom configuration; and
adjusting the second zoom configuration using the changed location.

15. A non-transitory computer readable medium comprising computer readable program code for:
presenting a visual stream using a first zoom configuration for a zoom state;
detecting an attention gesture from a set of first images from the visual stream;
adjusting the zoom state from the first zoom configuration to a second zoom configuration to zoom in on a person in response to detecting the attention gesture;
presenting the visual stream using the second zoom configuration after adjusting the zoom state to the second zoom configuration;
determining, from a set of second images from the visual stream, whether the person is speaking;
adjusting the zoom state to the first zoom configuration to zoom out from the person in response to determining that the person is not speaking; and
presenting the visual stream using the first zoom configuration after adjusting the zoom state to the first zoom configuration.

16. The non-transitory computer readable medium of claim 15, wherein the computer readable program code for detecting the attention gesture further comprises computer readable program code for:
detecting a set of keypoints for the person from a first image from the set of first images; and
detecting the attention gesture from the set of keypoints that indicates the person is requesting attention.

17. The non-transitory computer readable medium of claim 15, wherein the computer readable program code for detecting the attention gesture further comprises computer readable program code for:
detecting a location of the person from an image from the set of first images; and
detecting an attention gesture from the image at the location, wherein the second zoom configuration comprises an identifier of the location.

18. The non-transitory computer readable medium of claim 15, wherein the computer readable program code for determining whether the person is speaking further comprising computer readable program code for:
detecting a facial landmark set for the person from an image of the set of second images; and
detecting that the person is speaking from a plurality of facial landmark sets that include the facial landmark set.

19. The non-transitory computer readable medium of claim 15, wherein the computer readable program code for determining whether the person is speaking further comprising computer readable program code for:
queueing an image of the set of second images into an image queue; and
detecting that the person is speaking from the image queue using a machine learning algorithm.

20. The non-transitory computer readable medium of claim 15, further comprising computer readable program code for:
detecting the attention gesture after determining that the zoom state includes the first zoom configuration;
determining whether the person is speaking after determining that the zoom state includes the second zoom configuration;
detecting a changed location of the person while presenting the visual stream using the second zoom configuration; and
adjusting the second zoom configuration using the changed location.
